(19) United States
(12) Patent Application Publication
(10) Pub. No.: US 2007/0240013 A1
(43) Pub. Date: Oct. 11, 2007

(54) Methods And Apparatus For Managing Defective Processors Through Clock Programming

(75) Inventors: Atsushi Hayashi, Kanagawa (JP); Akiyuki Hatakeyama, Tokyo (JP); Taichi Niki, Kanagawa (JP); Yoichi Nishino, Tokyo (JP)

Correspondence Address: KAPLAN GILMAN GIBSON & DERNIER L.L.P., 900 ROUTE 9 NORTH, WOODBRIDGE, NJ, 07095, US

(73) Assignee: SONY COMPUTER ENTERTAINMENT INC., Tokyo (JP)

(21) Appl. No.: 11/620,877

(22) Filed: Jan. 8, 2007

Related U.S. Application Data
(60) Provisional application No. 60/762,803, filed on Jan. 27, 2006.

(51) Int. Cl. G06F 1/00

(52) U.S. Cl. 713/501

(57) ABSTRACT

An apparatus is disclosed which may include a plurality of circuit blocks, each circuit block including a separate clock grid; at least one oscillator circuit operable to select frequencies for at least two respective clock signals and to transmit the at least two clock signals to respective ones of said plurality of circuit blocks; and a control circuit coupled to the at least one oscillator circuit.

### CROSS REFERENCE TO RELATED APPLICATIONS

This application claims the benefit of U.S. Provisional Patent Application No. 60/762,803, filed Jan. 27, 2006, the entire disclosure of which is hereby incorporated by reference.

### BACKGROUND OF THE INVENTION

The present invention relates to methods and apparatus for managing defective processors of a multiprocessing system within an integrated circuit.

Large scale integrated circuits are being designed to accommodate an ever increasing number of circuits in order to achieve higher and higher functionality. For example, digital circuits (as well as analog circuits) are being designed with very high numbers of gates and other functional circuitry to meet processing objectives in the marketplace. As the complexity of integrated circuits (ICs) continues to increase, however, the number of transistors and other components used to implement the circuitry also increases, and the probability of a faulty component or circuit being present in an IC approaches one. The existence of a faulty circuit or component may require that the IC be discarded. However, the costs of materials and of processing incurred prior to the time at which the fault is detected make the option of discarding a faulty IC prohibitively expensive.

It has been proposed to use redundant circuits on the IC in order to permit replacement of the circuitry containing a faulty component. Thus, using such an implementation, even when a fault occurs, the IC may be salvaged by enabling the redundant circuit. This can increase the IC yield and save the IC manufacturer a considerable amount of money.

The components or circuits of an IC may be faulty due to improper fabrication. For example, an imperfection may have been present on the substrate during fabrication or the fabrication procedure itself may be faulty. Improperly fabricated ICs may be discovered during IC testing, prior to packaging. If a faulty component is discovered on an IC during pre-packaging IC testing, the faulty component may be deactivated and one or more of the redundant circuits activated to take its place through the blowing of certain fuses, preferably, laser fuses since access to the IC is possible because the IC has yet to be packaged.

In order to minimize the complexity of the power and clock distribution networks of the IC, the redundant circuitry usually shares common power and clock distribution networks with the other circuits of the IC. Thus, throughout most of the IC, the redundant circuitry is being actively clocked and powered although it is not being used. This can increase power consumption of the IC. Similarly, when a circuit containing a fault is disabled, it is still actively clocked and powered, which also contributes to the power consumption problem.

Because of the expense incurred by discarding ICs having faulty components and the power consumption problem associated with the implementation of redundant circuitry, there is a need in the art for an improved method for dealing with ICs having one or more faulty components or circuits therein.

### SUMMARY OF THE INVENTION

According to one aspect, the present invention may provide an apparatus, comprising: a plurality of circuit blocks, each circuit block including a separate clock grid; and at least one oscillator circuit operable to select frequencies for at least two respective clock signals and to transmit the at least two clock signals to respective ones of the plurality of circuit blocks. Preferably, the oscillator circuit is operable to select one of the frequencies for each circuit block. Preferably, the frequency for each circuit block is selected based on a test result for each circuit block. Preferably, the frequency for each circuit block is selected based on a desired power consumption level of each circuit block. Preferably, the frequency for each circuit block is selected based on a desired power consumption level of the apparatus. Preferably, the apparatus further comprises a control circuit coupled to the at least one oscillator circuit, wherein the at least one oscillator circuit is operable to select the frequencies in response to control data, received from the control circuit, indicative of the selected frequencies for the plurality of respective circuit blocks.

Preferably, the control circuit comprises a storage circuit including at least one of: (i) one or more read-only memories (ROMs); and (ii) one or more electronic fuses for storing the control data. Preferably, the control circuit further comprises a communication circuit operable to transmit the control data from the storage circuit to the at least one oscillator circuit. Preferably, the at least one oscillator circuit comprises at least two oscillators, each oscillator coupled to a respective one of the circuit blocks, the apparatus further comprising: a control circuit including at least one storage circuit and at least one communication circuit, the control circuit providing control data to the oscillator circuit for the selection of the frequencies for the clock signals. Preferably, the at least one communication circuit comprises at least one data bus operable to transmit the control data from the control circuit to the at least two oscillators. Preferably, the at least one oscillator circuit comprises at least two oscillators and at least two multiplexers, each multiplexer coupled to a respective one of the circuit blocks, the apparatus further comprising: a control circuit including at least one ROM and at least one communication circuit, wherein the control circuit is operable to transmit control data, indicative of the selected frequencies of the clock signals for the circuit blocks, to the at least one oscillator circuit. Preferably, the at least one communication circuit comprises a plurality of signal lines coupled to respective ones of the multiplexers and operable to transmit the control data thereto.

According to another aspect, the present invention may provide a method, comprising: providing a plurality of circuit blocks within an apparatus, each circuit block including a separate clock grid; selecting respective frequencies for at least two respective clock signals; and transmitting the at least two clock signals having the respective clock-signal frequencies to at least two of the circuit blocks. Preferably, the selecting comprises selecting one frequency for each circuit block. Preferably, the frequency for each circuit block is selected based on a test result for each circuit block. Preferably, the test result for each circuit block is obtained before the apparatus is packaged.

Preferably, the frequency for each circuit block is selected based on a desired power consumption level for each circuit block. Preferably, the frequency for each circuit block is selected based on a desired power consumption level for the apparatus. Preferably, the selecting is responsive to control data indicative of the selected frequencies for the plurality of respective circuit blocks. Preferably, the selecting and the transmitting are performed by an oscillator circuit within the apparatus. Preferably, the control data is transmitted to the oscillator circuit from a control circuit within the apparatus.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram illustrating the use of a single, common clock signal for a system including a plurality of circuit blocks in accordance with the prior art;

FIG. 2 is a block diagram illustrating the structure of a system including a plurality of circuit blocks in accordance with one or more embodiments of the present invention;

FIG. 3 is a block diagram illustrating the structure of a system including a plurality of circuit blocks in accordance with one or more alternative embodiments of the present invention;

FIG. 4 is a flow diagram of a method that may be practiced employing the systems of FIGS. 2 or 3 (or other systems described herein) according to one or more embodiments of the present invention;

FIG. 5 is a diagram illustrating a multiprocessing system that may be adapted to utilize the clock signal selection apparatus and method discussed above in order to achieve one or more further embodiments of the present invention;

FIG. 6 is a diagram illustrating a processor element (PE) that may be used to implement one or more further aspects of the present invention;

FIG. 7 is a diagram illustrating the structure of an exemplary sub processing unit (SPU) of the system of FIG. 6 that may be adapted in accordance with one or more further aspects of the present invention; and

FIG. 8 is a diagram illustrating the structure of an exemplary processing unit (PU) of the system of FIG. 6 that may be adapted in accordance with one or more further aspects of the present invention.

### DETAILED DESCRIPTION OF THE PREFERRED EMBODIMENTS

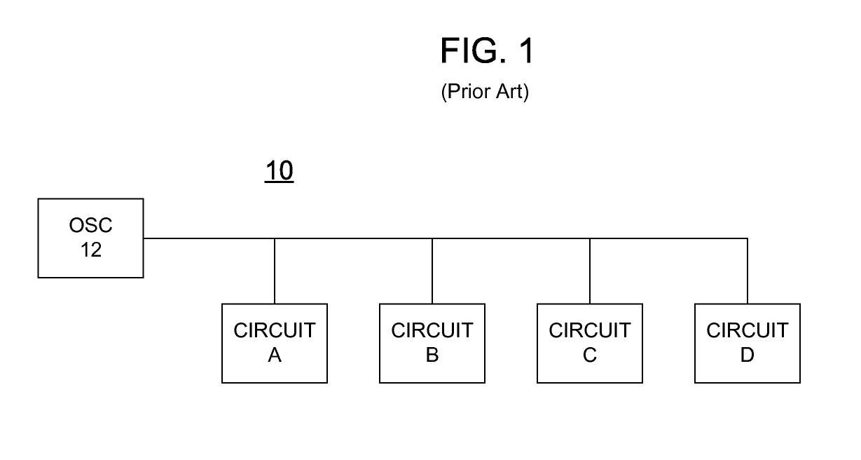

FIG. 1 is a block diagram illustrating the use of a common clock signal source for a system 10 including a plurality of circuit blocks in accordance with the prior art. Generally, employing existing approaches, system 10 would be tested employing a clock signal frequency from the phase-locked loop (PLL) 12 consistent with the frequency at which the circuits of system 10 would be expected to receive in commercial use. For the sake of discussion herein, a clock signal frequency of 4 GHz (gigahertz) could be used. Generally, any circuit not functioning properly at this testing frequency would be considered faulty, and the options discussed in the Background section herein would have to be selected from.

Specifically, upon discovering a faulty circuit within system 10, the system 10 could be discarded. However, this option, as discussed above, incurs considerable expense since the entire cost of manufacturing system 10 up to the point at which the testing occurs will have been wasted.

Alternatively, one or more of circuits A-D may be employed as redundant circuitry, and the faulty circuit may remain unused once system 10 is in service. However, under this approach, the faulty, unused circuit will still be connected to the clock signal and to a power supply (not shown), thereby wasting power during operation of system 10.

An approach to the evaluation of multi-circuit systems in accordance with one or more aspects of the present invention may include testing the circuits of a system at a range of clock signal frequencies to provide a test result indicative of the clock-signal frequencies at which the respective circuits may perform properly. Thereafter, measures may be taken to ensure that each processor within a system receives a clock signal having a frequency consistent with the test result obtained for that processor during the testing procedure. Thus, under this approach, the all-or-nothing circuit assessment of the prior art may be replaced by a circuit evaluation method that provides a sliding scale of performance evaluation for each circuit. In this manner, a system including a circuit capable of operating with a clock signal having a reduced frequency of 2 GHz (as opposed to 4 GHz), for example, may be salvageable even though not able to operate at the highest anticipated performance level. In the following, apparatus and methods implementing one or more of the above concepts are described.

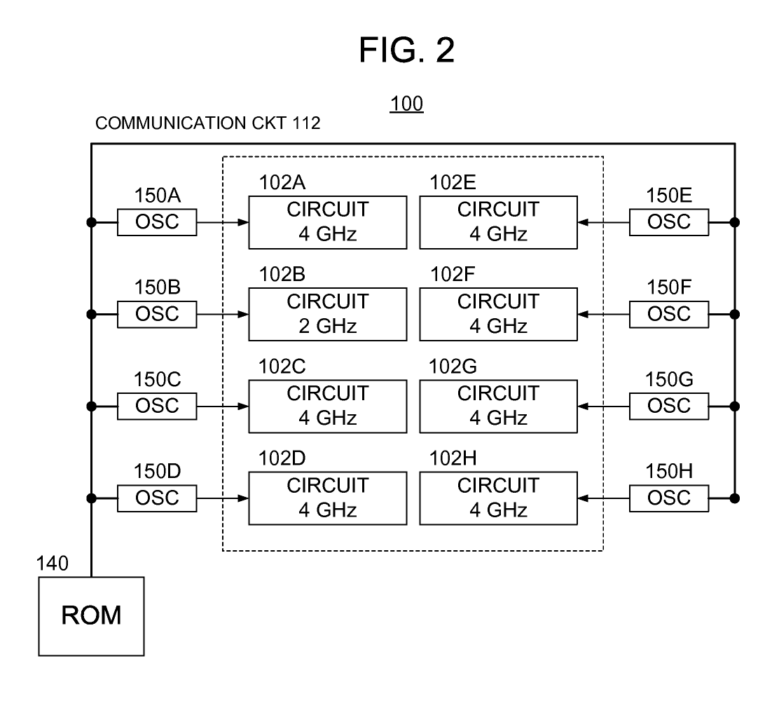

With reference to the drawings, wherein like numerals indicate like elements, there is shown in FIG. 2 a system 100 that may be adapted for carrying out one or more features of the present invention. For the purposes of brevity and clarity, the block diagram of FIG. 2 will be referred to and described herein as illustrating an apparatus 100, it being understood, however, that the description may readily be applied to various aspects of a method with equal force.

Apparatus 100 preferably includes a plurality of circuit blocks 102A-H, a plurality of oscillators 150A-H, at least one read-only memory (ROM) 140, and at least one communication circuit 112. For the sake of convenience, the terms “oscillator circuit” and “control circuit” are used herein to denote selected combinations of the above-recited components. In one or more embodiments, including that of FIG. 2, the oscillator circuit may include one or more of oscillators 150A-H, and the control circuit may include one or both of ROM 140 and communication circuit 112.

It is understood that any number of circuit blocks 102 may be employed without departing from the spirit and scope of the one or more embodiments of the invention. The circuit blocks 102 are generally operable to produce one or more output signals in response to operating power and one or more input signals. For example, the circuit blocks 102 may be digital circuits, such as combinational logic circuits, processing circuits, microprocessor circuits, digital signal processing circuits, etc.

In one or more embodiments, circuit blocks 102 are processors 102 that may be implemented utilizing any of the known technologies that are capable of requesting data from a system memory (not shown), and manipulating the data to achieve a desirable result. For example, the processors 102 may be implemented using any of the known microprocessors that are capable of executing software and/or firmware, including standard microprocessors, distributed microprocessors, etc. By way of example, the processors 102 may be graphics processors that are capable of requesting and manipulating data, such as pixel data, including gray-scale information, color information, texture data, polygonal information, video frame information, etc.

In one or more embodiments, any number of read-only memories 140 may be employed. In general, any form of non-volatile data storage equipment may be substituted for ROM 140.

ROM 140 may store information suitable for selecting which of a plurality of available frequencies may be output from each of oscillators 150. Such frequency selection information is referred to herein as “control data” or “control signals.” ROM 140 is preferably permanently configured during the manufacture of apparatus 100 to enable suitable frequency selection for each oscillator 150. Alternatively, other permanently configurable devices such as e-fuses may be deployed in place of ROM 140. In still other alternative embodiments, ROM 140 could be configured to be alterable after packaging of apparatus 100 is complete. In this case, pins may be made available on the exterior of apparatus 100 to enable an external device to appropriately access ROM 140 for such post-packaging access.

In one or more embodiments, communication circuit 112 may include a data bus which may transmit address data and control data from ROM 140 to oscillators 150.

In one or more embodiments, oscillators 150 may be operable to provide clock signals at selected frequencies to their respective circuit blocks 102. The frequency of the provided clock signal may be selected in response to control data received at each oscillator 150 from ROM 140. Each oscillator 150 may be a PLL or other programmable clock able to output at least one signal at a selectable frequency.

Those skilled in the art will appreciate that numerous approaches may be employed to ensure that the appropriate control signals are received by the proper oscillator 150. For example, in one or more alternative embodiments, communication circuit 112 may include a plurality of dedicated signal lines that separately connect ROM 140 to each of the oscillators 150. Where dedicated signal lines are deployed, the data transmitted to the oscillators along the signal lines may be simplified to include only control data, since address data are preferably not required.

In one or more embodiments employing a data bus (instead of or in addition to dedicated signal lines), ROM 140 may further store addressing information for directing this control data to the appropriate oscillator 150. Thus, for example, where there are eight circuit blocks 102 that can be specified (as in FIG. 2) and four frequencies that can be selected, a five-bit sequence could be employed. Specifically, the first three bits of this sequence could specify the circuit block 102 to which the control data is being directed, and the last two bits could contain the control data for selecting the frequency of a clock signal to be provided by oscillator 150. It is understood that fewer or more than eight processors may be employed and thus fewer or more than three bits could be employed for addressing the processors. Moreover, fewer or more than four clock signal frequencies may be available at each oscillator 150, and thus fewer or more than two bits may be employed to select these frequencies.

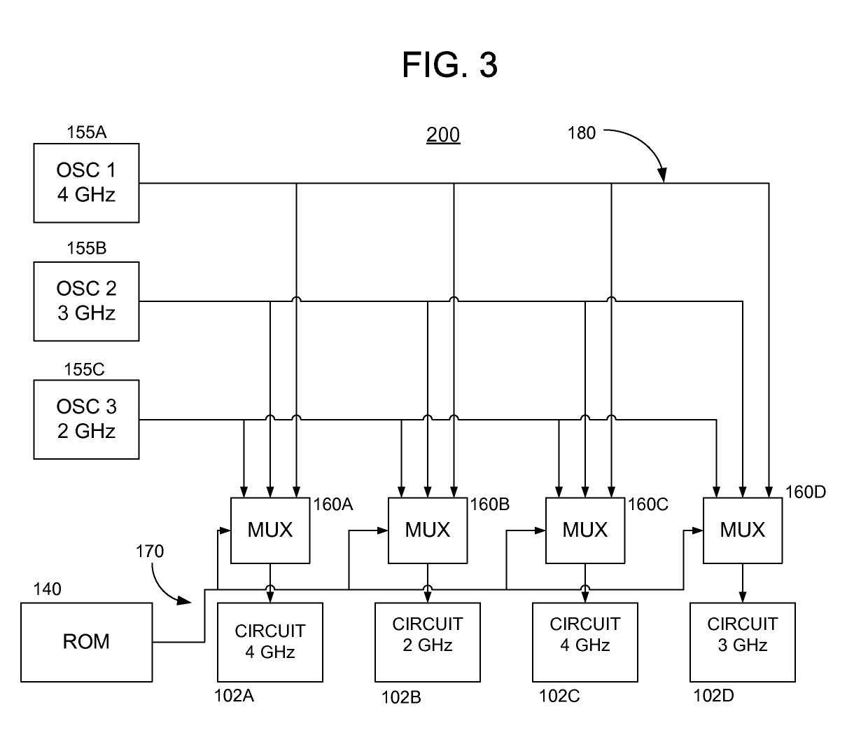

With reference to FIG. 3, there is shown a system 200 that may be adapted for carrying out one or more features of the present invention. For the purposes of brevity and clarity, the block diagram of FIG. 3 will be referred to and described herein as illustrating an apparatus 200, it being understood, however, that the description may readily be applied to various aspects of a method with equal force.

Apparatus 200 preferably includes a plurality of circuit blocks 102, ROM 140, a plurality of oscillators 155, a plurality of multiplexers 160, oscillator signal lines 180, and communication circuit 170. For the sake of convenience, as with the embodiment shown in FIG. 2, the terms “oscillator circuit” and “control circuit” are used herein to denote selected combinations of the above-recited components. In one or more embodiments, including that of FIG. 3, the oscillator circuit may include one or more of oscillators 155A-C and one or more of multiplexers 160A-D, and the control circuit may include one or both of ROM 140 and communication circuit 170.

As with the embodiment of FIG. 2, any number of circuit blocks 102 may be employed without departing from the spirit and scope of the one or more embodiments of the invention. Circuit blocks 102 of FIG. 3 may be the same as the like-numbered circuit blocks of FIG. 2. Accordingly, the description provided for circuit blocks 102 provided earlier herein in connection with FIG. 2 is applicable to circuit blocks 102 of FIG. 3, and that description is therefore not repeated in this section.

ROM 140 of FIG. 3 preferably substantially corresponds to ROM 140 discussed in connection with FIG. 2. Accordingly, the description of ROM 140 is not repeated in this section. In one or more embodiments, where communication circuit 170 includes dedicated signal lines connected to each multiplexer 160, the storage of address information to direct the transmission of control data, as discussed in connection with FIG. 2, may be omitted. However, in other embodiments, such address information may be included within ROM 140.

Oscillators 155 may be PLLs or other form of programmable clock. In one or more embodiments, including that shown in FIG. 3, each oscillator 155 is preferably configured to provide a clock signal at a single frequency, which may be determined at the time of manufacture of apparatus 200 (i.e. prior to packaging apparatus 200). However, in one or more alternative embodiments, pins may be disposed on the package of apparatus 200 to enable the setting of the frequencies of oscillators 155 after the packaging of apparatus 200.

Multiplexers 160 are preferably each operable to select one output clock signal, from a plurality of input clock signals, for transmission to that multiplexer's corresponding circuit block 102. In one or more embodiments, the number of multiplexers 160 may equal the number of circuit blocks to enable the selection of one clock signal for each circuit block 102. However, in one or more alternative embodiments, the number of multiplexers 160 may be greater or smaller than the number of circuit blocks 102.

In one or more embodiments, oscillator signal lines 180 are preferably operable to transmit oscillator signals from the oscillators 155 to multiplexers 160. In one or more embodiments, including that shown in FIG. 3, oscillator signal lines 180 are configured such that each oscillator 155 is connected to all of the multiplexers 160. However, the present invention is not limited to this arrangement, and other configurations may be implemented.

In one or more embodiments, communication circuit 170 may include dedicated signal lines that separately connect ROM 140 to each of the multiplexers 160. Alternatively, communication circuit 170 may include an address and/or data bus (bus). In one or more embodiments, communication circuit 170 may be operable to transmit control data from ROM 140 to multiplexers 160.

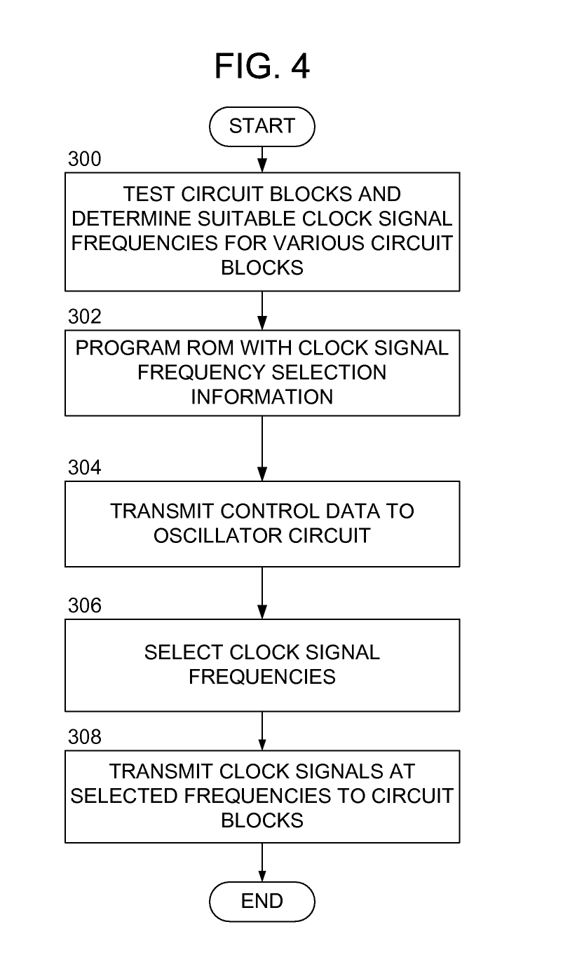

FIG. 4 is a flow diagram of a method that may be practiced employing the systems of FIGS. 2 or 3 (or other systems described herein) according to one or more embodiments of the present invention. In the following, the term “apparatus” may refer to either apparatus 100, apparatus 200, or any other apparatus consistent with the inventive principles disclosed herein.

At step 300, circuit blocks 102 are preferably tested to determine suitable clock signal frequencies for each of the processors within an apparatus. Such tests may be conducted at a selection of different frequencies that are within an order of magnitude of the highest clock signal frequency at which a circuit block is expected to operate.

For example, where each circuit block 102 is expected to operate at 4 GHz, circuit blocks may be tested at frequencies between 1 GHz and 4 GHz at intervals of 1 GHz. In general, circuit blocks 102 may be tested at frequencies in between the highest frequency at which they are expected to operate and the lowest frequency at which a circuit block 102 may perform some useful function. Preferably, a test result for each circuit block 102 is generated from step 300 which may be used to determine the clock signal to be provided to each such circuit block 102.

Thus, whereas the prior art assigns either a “working” or “faulty” status to a circuit, one or more embodiments of the present invention preferably assign frequency “ratings” that determine the frequency at which each circuit block 102 will operate for the working life of that circuit block and/or the working life of the apparatus in which that circuit block is located. However, in alternative embodiments, an ability to change the frequency of a clock signal supplied to a particular circuit block, during the operating life of this circuit block, may be implemented.

In one or more embodiments, the above-discussed testing may take place after fabrication of the apparatus and prior to packaging of same. Testing at this stage may uncover defects introduced by the fabrication process that could not have been detected earlier. However, in one or more alternative embodiments, provision may be made for testing circuit blocks 102 after packaging. In this case, pins are preferably provided in the apparatus package to enable external access to the individual circuit blocks 102 after packaging is complete.

At step 302, ROM 140 (or an alternative frequency selection device such as e-fuses) may be programmed with control data indicating what clock signal frequency will be provided to each circuit block 102. Preferably, this programming is performed after fabrication and prior to the packaging of apparatus 100 (or apparatus 200) since access to ROM 140 may not be available after packaging of apparatus 100 and/or 200 is complete. Moreover, the programming of ROM 140 preferably determines the clock signal frequencies to be used within apparatus 100/200 for the life thereof.

However, in one or more alternative embodiments, pins may be deployed on apparatus 100 and/or 200 to enable access to ROM 140 after packaging is complete and to thereby enable programming ROM 140 after apparatus 100 and/or 200 is packaged. Under this approach, the programming of ROM 140 may be alterable after having been performed for the first time.

In one or more embodiments, the clock-signal frequency selected for use with a circuit block 102 may be decided by the frequency rating of that circuit block 102 as indicated by the test result obtained by testing in step 300. However, in one or more alternative embodiments, the frequency of the clock signal for each circuit block 102 may be selected based on a desired power consumption level for each such circuit block 102 and/or on a desired power consumption level for the apparatus in which each such circuit block 102 is located.

At step 304, control data, which may represent frequency selection information, may be transmitted to an oscillator circuit, where the “oscillator circuit” may include components that generate and/or select clock signals for transmission to circuit blocks 102.

In one or more embodiments, including that shown in FIG. 2, the oscillator circuit may include oscillators 150A-H. In one or more other embodiments, including that shown in FIG. 3, the oscillator circuit may include oscillators 150A-C and multiplexers 160A-D.

In one or more embodiments, including that shown in FIG. 2, the control data are preferably transmitted from ROM 140 along communication circuit 112 to circuit blocks 102A-H. Communication circuit 112 may be a bus or may include a plurality of dedicated signal lines that are separately coupled to oscillator 102. In one or more other embodiments, such as that shown in FIG. 3, the control data are preferably transmitted from ROM 140 along communication circuit 170, which may include a plurality of control signal lines, to multiplexers 160A-D.

At step 306, clock signal frequencies are preferably selected in response to the control data transmitted in step 304. In one or more embodiments, including that shown in FIG. 2, the clock frequency to be supplied to each circuit block 102 is preferably selected within the oscillator 150 connected to that circuit block 102 in response to the control data received by the oscillator 150.

In one or more other embodiments, including that shown in FIG. 3, the oscillators preferably provide a clock signal having a constant frequency to a plurality of multiplexers 160, with each multiplexer being coupled in turn to a corresponding circuit block 102. Thus, each multiplexer 160 may continuously receive a plurality of clock signals at different frequencies. Upon receipt of the control data from ROM 140, each multiplexer preferably selects one clock signal from among the plurality of clock signals being received at each such multiplexer, in response to the received control data, for transmission to the circuit block 102 coupled to each such multiplexer.

At step 308, the multiplexers 160 preferably transmit the selected clock signals to the respective circuit blocks. In one or more embodiments, including that shown in FIG. 2, the frequency selected in the manner discussed above is preferably transmitted directly from each oscillator 150 to its corresponding circuit block 102. In one or more embodiments, including that shown in FIG. 3, the clock signal selected within each multiplexer 160 is preferably transmitted from each such multiplexer 160 to its corresponding circuit block 102.

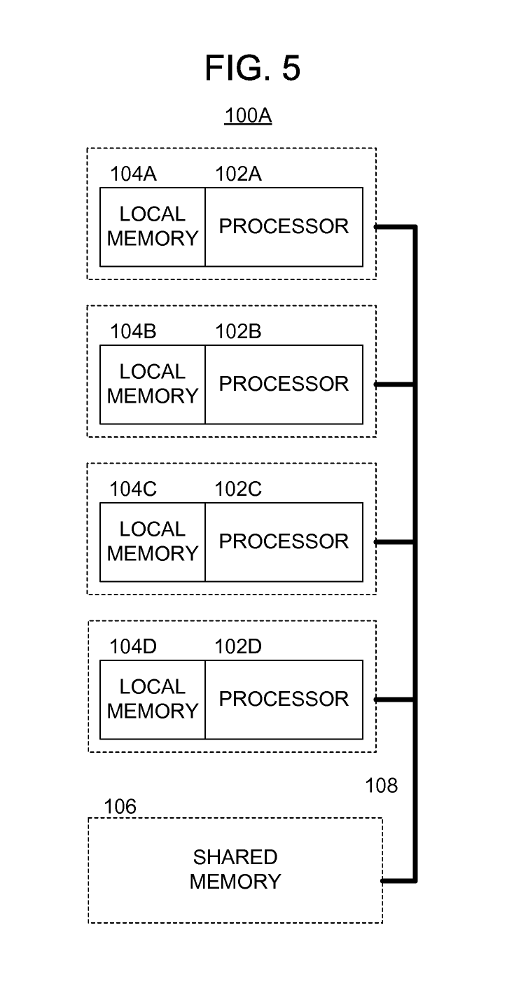

FIG. 5 is a block diagram of a multi-processing system 100A that may be adapted to implement the features discussed herein and one or more further embodiments of the present invention. The system 100A includes a plurality of processors 102A-D, associated local memories 104A-D, and a shared memory 106 interconnected by way of a bus 108. The shared memory 106 may also be referred to herein as a main memory or system memory. The methods and/or circuit functionality discussed above may also be applied to the circuit configuration of FIG. 5, where the processors 102 are the circuit blocks discussed above.

Although four processors 102 are illustrated by way of example, any number may be utilized without departing from the spirit and scope of the present invention. Each of the processors 102 may be of similar construction or of differing construction. The local memories 104 are preferably located on the same chip (same semiconductor substrate) as their respective processors 102; however, the local memories 104 are preferably not traditional hardware cache memories in that there are no on chip or off chip hardware cache circuits, cache registers, cache memory controllers, etc. to implement a hardware cache memory function.

The processors 102 preferably provide data access requests to copy data (which may include program data) from the system memory 106 over the bus 108 into their respective local memories 104 for program execution and data manipulation. The mechanism for facilitating data access is preferably implemented utilizing a direct memory access controller (DMAC), not shown. The DMAC of each processor is preferably of substantially the same capabilities as discussed hereinabove with respect to other features of the invention.

The system memory 106 is preferably a dynamic random access memory (DRAM) coupled to the processors 102 through a high bandwidth memory connection (not shown). Although the system memory 106 is preferably a DRAM, the memory 106 may be implemented using other means, e.g., a static random access memory (SRAM), a magnetic random access memory (MRAM), an optical memory, a holographic memory, etc.

Each processor 102 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processors 102 may include an instruction buffer, instruction decode circuitry, dependency check circuitry, instruction issue circuitry, and execution stages.

In one or more embodiments, the processors 102 and the local memories 104 may be disposed on a common semiconductor substrate. In one or more further embodiments, the shared memory 106 may also be disposed on the common semiconductor substrate or it may be separately disposed.

In one or more alternative embodiments, one or more of the processors 102 may operate as a main processor operatively coupled to the other processors 102 and capable of being coupled to the shared memory 106 over the bus 108. The main processor may schedule and orchestrate the processing of data by the other processors 102. Unlike the other processors 102, however, the main processor may be coupled to a hardware cache memory, which is operable cache data obtained from at least one of the shared memory 106 and one or more of the local memories 104 of the processors 102. The main processor may provide data access requests to copy data (which may include program data) from the system memory 106 over the bus 108 into the cache memory for program execution and data manipulation utilizing any of the known techniques, such as DMA techniques.

A description of a preferred computer architecture for a multi-processor system will now be provided that is suitable for carrying out one or more of the features discussed herein. In accordance with one or more embodiments, the multi-processor system may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor in the multi-processor system must complete tasks in a short and predictable time.

To this end, and in accordance with this computer architecture, all processors of a multi processing computer system are constructed from a common computing module (or cell). This common computing module has a consistent structure and preferably employs the same instruction set architecture. The multi processing computer system can be formed of one or more clients, servers, PCs, mobile computers, game machines, PDAs, set top boxes, appliances, digital televisions and other devices using computer processors.

A plurality of the computer systems may also be members of a network if desired. The consistent modular structure enables efficient, high speed processing of applications and data by the multi processing computer system, and if a network is employed, the rapid transmission of applications and data over the network. This structure also simplifies the building of members of the network of various sizes and processing power and the preparation of applications for processing by these members.

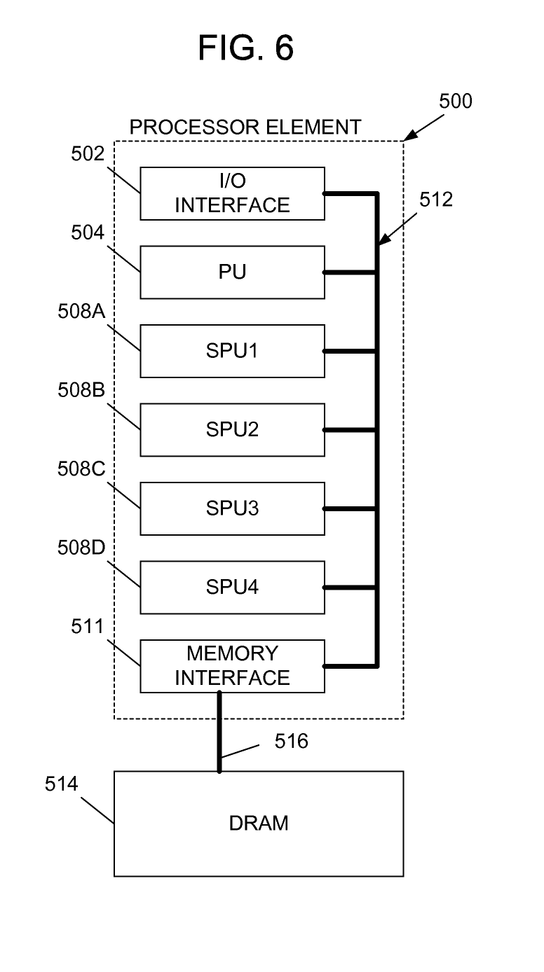

With reference to FIG. 6, the basic processing module is a processor element (PE) 500. The PE 500 comprises an I/O interface 502, a processing unit (PU) 504, and a plurality of sub processing units 508, namely, sub processing unit 508A, sub processing unit 508B, sub processing unit 508C, and sub processing unit 508D. A local (or internal) PE bus 512 transmits data and applications among the PU 504, the sub processing units 508, and a memory interface 511. The local PE bus 512 can have, e.g., a conventional architecture or can be implemented as a packet-switched network. If implemented as a packet switch network, while requiring more hardware, increases the available bandwidth.

The PE 500 can be constructed using various methods for implementing digital logic. The PE 500 preferably is constructed, however, as a single integrated circuit employing a complementary metal oxide semiconductor (CMOS) on a silicon substrate. Alternative materials for substrates include gallium arsinide, gallium aluminum arsinide and other so called III B compounds employing a wide variety of dopants. The PE 500 also may be implemented using superconducting material, e.g., rapid single flux quantum (RSFQ) logic.

The PE 500 is closely associated with a shared (main) memory 514 through a high bandwidth memory connection 516. Although the memory 514 preferably is a dynamic random access memory (DRAM), the memory 514 could be implemented using other means, e.g., as a static random access memory (SRAM), a magnetic random access memory (MRAM), an optical memory, a holographic memory, etc.

The PU 504 and the sub-processing units 508 are preferably each coupled to a memory flow controller (MFC) including direct memory access DMA functionality, which in combination with the memory interface 511, facilitate the transfer of data between the DRAM 514 and the sub processing units 508 and the PU 504 of the PE 500. It is noted that the DMAC and/or the memory interface 511 may be integrally or separately disposed with respect to the sub processing units 508 and the PU 504. Indeed, the DMAC function and/or the memory interface 511 function may be integral with one or more (preferably all) of the sub processing units 508 and the PU 504. It is also noted that the DRAM 514 may be integrally or separately disposed with respect to the PE 500. For example, the DRAM 514 may be disposed off-chip as is implied by the illustration shown or the DRAM 514 may be disposed on-chip in an integrated fashion.

The PU 504 can be, e.g., a standard processor capable of stand alone processing of data and applications. In operation, the PU 504 preferably schedules and orchestrates the processing of data and applications by the sub processing units. The sub processing units preferably are single instruction, multiple data (SIMD) processors. Under the control of the PU 504, the sub processing units perform the processing of these data and applications in a parallel and independent manner. The PU 504 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PU 504 may be implemented by one of the sub processing units 508 taking on the role of a main processing unit that schedules and orchestrates the processing of data and applications by the sub processing units 508. Further, there may be more than one PU implemented within the processor element 500.

In accordance with this modular structure, the number of PEs 500 employed by a particular computer system is based upon the processing power required by that system. For example, a server may employ four PEs 500, a workstation may employ two PEs 500 and a PDA may employ one PE 500. The number of sub processing units of a PE 500 assigned to processing a particular software cell depends upon the complexity and magnitude of the programs and data within the cell.

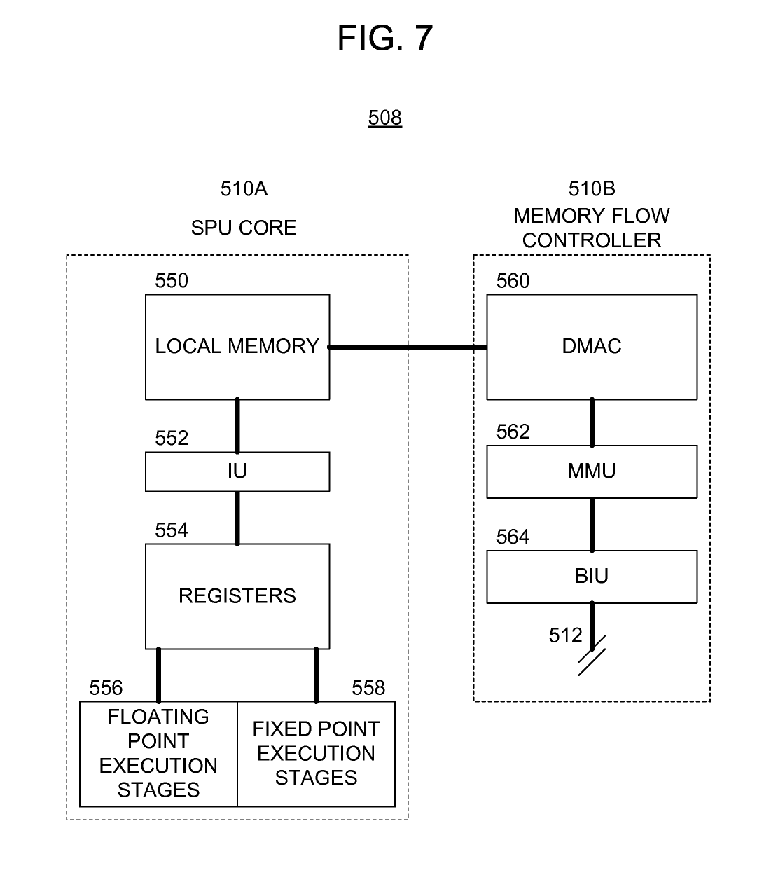

FIG. 7 illustrates the preferred structure and function of a sub processing unit (SPU) 508. The SPU 508 architecture preferably fills a void between general-purpose processors (which are designed to achieve high average performance on a broad set of applications) and special-purpose processors (which are designed to achieve high performance on a single application). The SPU 508 is designed to achieve high performance on game applications, media applications, broadband systems, etc., and to provide a high degree of control to programmers of real-time applications. Some capabilities of the SPU 508 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The sub processing unit 508 includes two basic functional units, namely an SPU core 510A and a memory flow controller (MFC) 510B. The SPU core 510A performs program execution, data manipulation, etc., while the MFC 510B performs functions related to data transfers between the SPU core 510A and the DRAM 514 of the system.

The SPU core 510A includes a local memory 550, an instruction unit (IU) 552, registers 554, one ore more floating point execution stages 556 and one or more fixed point execution stages 558. The local memory 550 is preferably implemented using single-ported random access memory, such as an SRAM. Whereas most processors reduce latency to memory by employing caches, the SPU core 510A implements the relatively small local memory 550 rather than a cache. Indeed, in order to provide consistent and predictable memory access latency for programmers of real-time applications (and other applications as mentioned herein) a cache memory architecture within the SPU 508A is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 550 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the sub-processing units 508 references the associated local memory 550 using a local address, however, each location of the local memory 550 is also assigned a real address (RA) within the overall system's memory map. This allows Privilege Software to map a local memory 550 into the Effective Address (EA) of a process to facilitate DMA transfers between one local memory 550 and another local memory 550. The PU 504 can also directly access the local memory 550 using an effective address. In a preferred embodiment, the local memory 550 contains 556 kilobytes of storage, and the capacity of registers 552 is 128×128 bits.

The SPU core 504A is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 552 includes an instruction buffer, instruction decode circuitry, dependency check circuitry, and instruction issue circuitry.

The instruction buffer preferably includes a plurality of registers that are coupled to the local memory 550 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro-operations that perform the function of the corresponding instruction. For example, the logical micro-operations may specify arithmetic and logical operations, load and store operations to the local memory 550, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decoder circuitry 112 simultaneously.

The instruction issue circuitry is operable to issue the instructions to the floating point execution stages 556 and/or the fixed point execution stages 558.

The registers 554 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU core 510A is of a superscalar architecture, such that more than one instruction is issued per clock cycle. The SPU core 510A preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 556 and fixed point execution stages 558 may be employed. In a preferred embodiment, the floating point execution stages 556 operate at a speed of 32 billion floating point operations per second (32 GFLOPS), and the fixed point execution stages 558 operate at a speed of 32 billion operations per second (32 GOPS).

The MFC 510B preferably includes a bus interface unit (BIU) 564, a memory management unit (MMU) 562, and a direct memory access controller (DMAC) 560. With the exception of the DMAC 560, the MFC 510B preferably runs at half frequency (half speed) as compared with the SPU core 510A and the bus 512 to meet low power dissipation design objectives. The MFC 510B is operable to handle data and instructions coming into the SPU 508 from the bus 512, provides address translation for the DMAC, and snoop-operations for data coherency. The BIU 564 provides an interface between the bus 512 and the MMU 562 and DMAC 560. Thus, the SPU 508 (including the SPU core 510A and the MFC 510B) and the DMAC 560 are connected physically and/or logically to the bus 512.

The MMU 562 is preferably operable to translate effective addresses (taken from DMA commands) into real addresses for memory access. For example, the MMU 562 may translate the higher order bits of the effective address into real address bits. The lower-order address bits, however, are preferably untranslatable and are considered both logical and physical for use to form the real address and request access to memory. In one or more embodiments, the MMU 562 may be implemented based on a 64-bit memory management model, and may provide 264 bytes of effective address space with 4K-, 64K-, 1M-, and 16M-byte page sizes and 256 MB segment sizes. Preferably, the MMU 562 is operable to support up to 265 bytes of virtual memory, and 242 bytes (4 TeraBytes) of physical memory for DMA commands. The hardware of the MMU 562 may include an 8-entry, fully associative SLB, a 256-entry, 4 way set associative TLB, and a 4×4 Replacement Management Table (RMT) for the TLB—used for hardware TLB miss handling.

The DMAC 560 is preferably operable to manage DMA commands from the SPU core 510A and one or more other devices such as the PU 504 and/or the other SPUs. There may be three categories of DMA commands: Put commands, which operate to move data from the local memory 550 to the shared memory 514; Get commands, which operate to move data into the local memory 550 from the shared memory 514; and Storage Control commands, which include SLI commands and synchronization commands. The synchronization commands may include atomic commands, send signal commands, and dedicated barrier commands. In response to DMA commands, the MMU 562 translates the effective address into a real address and the real address is forwarded to the BIU 564.

The SPU core 510A preferably uses a channel interface and data interface to communicate (send DMA commands, status, etc.) with an interface within the DMAC 560. The SPU core 510A dispatches DMA commands through the channel interface to a DMA queue in the DMAC 560. Once a DMA command is in the DMA queue, it is handled by issue and completion logic within the DMAC 560. When all bus transactions for a DMA command are finished, a completion signal is sent back to the SPU core 510A over the channel interface.

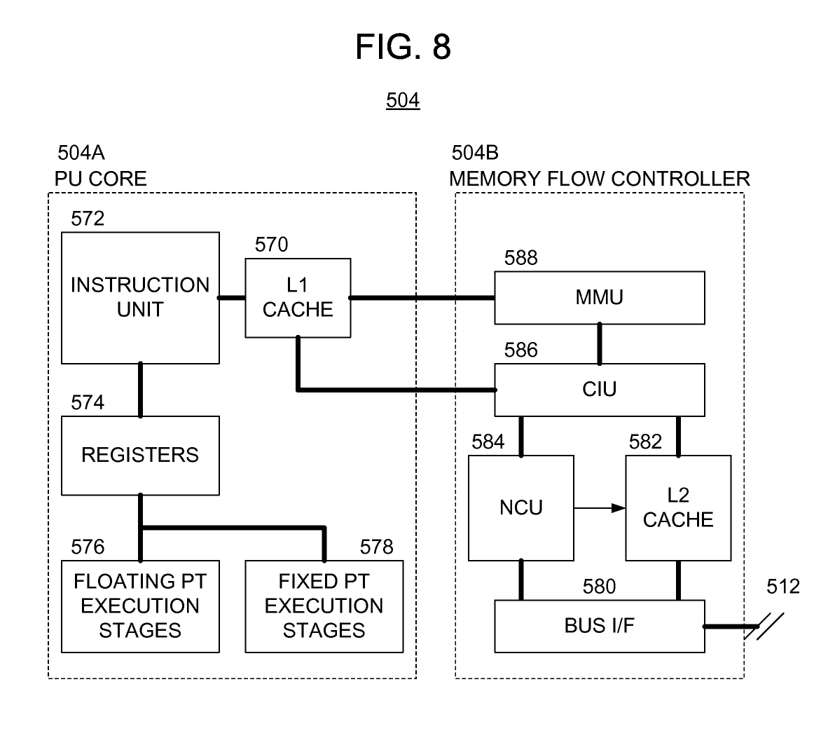

FIG. 8 illustrates the preferred structure and function of the PU 504. The PU 504 includes two basic functional units, the PU core 504A and the memory flow controller (MFC) 504B. The PU core 504A performs program execution, data manipulation, multi-processor management functions, etc., while the MFC 504B performs functions related to data transfers between the PU core 504A and the memory space of the system 100.

The PU core 504A may include an L1 cache 570, an instruction unit 572, registers 574, one or more floating point execution stages 576 and one or more fixed point execution stages 578. The L1 cache provides data caching functionality for data received from the shared memory 106, the processors 102, or other portions of the memory space through the MFC 504B. As the PU core 504A is preferably implemented as a superpipeline, the instruction unit 572 is preferably implemented as an instruction pipeline with many stages, including fetching, decoding, dependency checking, issuing, etc. The PU core 504A is also preferably of a superscalar configuration, whereby more than one instruction is issued from the instruction unit 572 per clock cycle. To achieve a high processing power, the floating point execution stages 576 and the fixed point execution stages 578 include a plurality of stages in a pipeline configuration. Depending upon the required processing power, a greater or lesser number of floating point execution stages 576 and fixed point execution stages 578 may be employed.

The MFC 504B includes a bus interface unit (BIU) 580, an L2 cache memory, a non-cachable unit (NCU) 584, a core interface unit (CIU) 586, and a memory management unit (MMU) 588. Most of the MFC 504B runs at half frequency (half speed) as compared with the PU core 504A and the bus 108 to meet low power dissipation design objectives.

The BIU 580 provides an interface between the bus 108 and the L2 cache 582 and NCU 584 logic blocks. To this end, the BIU 580 may act as a Master as well as a Slave device on the bus 108 in order to perform fully coherent memory operations. As a Master device it may source load/store requests to the bus 108 for service on behalf of the L2 cache 582 and the NCU 584. The BIU 580 may also implement a flow control mechanism for commands which limits the total number of commands that can be sent to the bus 108. The data operations on the bus 108 may be designed to take eight beats and, therefore, the BIU 580 is preferably designed around 128 byte cache-lines and the coherency and synchronization granularity is 128 KB.

The L2 cache memory 582 (and supporting hardware logic) is preferably designed to cache 512 KB of data. For example, the L2 cache 582 may handle cacheable loads/stores, data pre-fetches, instruction fetches, instruction pre-fetches, cache operations, and barrier operations. The L2 cache 582 is preferably an 8-way set associative system. The L2 cache 582 may include six reload queues matching six (6) castout queues (e.g., six RC machines), and eight (64-byte wide) store queues. The L2 cache 582 may operate to provide a backup copy of some or all of the data in the L1 cache 570. Advantageously, this is useful in restoring state(s) when processing nodes are hot-swapped. This configuration also permits the L1 cache 570 to operate more quickly with fewer ports, and permits faster cache-to-cache transfers (because the requests may stop at the L2 cache 582). This configuration also provides a mechanism for passing cache coherency management to the L2 cache memory 582.

The NCU 584 interfaces with the CIU 586, the L2 cache memory 582, and the BIU 580 and generally functions as a queueing/buffering circuit for non-cacheable operations between the PU core 504A and the memory system. The NCU 584 preferably handles all communications with the PU core 504A that are not handled by the L2 cache 582, such as cache-inhibited load/stores, barrier operations, and cache coherency operations. The NCU 584 is preferably run at half speed to meet the aforementioned power dissipation objectives.

The CIU 586 is disposed on the boundary of the MFC 504B and the PU core 504A and acts as a routing, arbitration, and flow control point for requests coming from the execution stages 576, 578, the instruction unit 572, and the MMU unit 588 and going to the L2 cache 582 and the NCU 584. The PU core 504A and the MMU 588 preferably run at full speed, while the L2 cache 582 and the NCU 584 are operable for a 2:1 speed ratio. Thus, a frequency boundary exists in the CIU 586 and one of its functions is to properly handle the frequency crossing as it forwards requests and reloads data between the two frequency domains.

The CIU 586 is comprised of three functional blocks: a load unit, a store unit, and reload unit. In addition, a data pre-fetch function is performed by the CIU 586 and is preferably a functional part of the load unit. The CIU 586 is preferably operable to: (i) accept load and store requests from the PU core 504A and the MMU 588; (ii) convert the requests from full speed clock frequency to half speed (a 2:1 clock frequency conversion); (iii) route cachable requests to the L2 cache 582, and route non-cachable requests to the NCU 584; (iv) arbitrate fairly between the requests to the L2 cache 582 and the NCU 584; (v) provide flow control over the dispatch to the L2 cache 582 and the NCU 584 so that the requests are received in a target window and overflow is avoided; (vi) accept load return data and route it to the execution stages 576, 578, the instruction unit 572, or the MMU 588; (vii) pass snoop requests to the execution stages 576, 578, the instruction unit 572, or the MMU 588; and (viii) convert load return data and snoop traffic from half speed to full speed.

The MMU 588 preferably provides address translation for the PU core 540A, such as by way of a second level address translation facility. A first level of translation is preferably provided in the PU core 504A by separate instruction and data ERAT (effective to real address translation) arrays that may be much smaller and faster than the MMU 588.

In a preferred embodiment, the PU 504 operates at 4-6 GHz, 10F04, with a 64-bit implementation. The registers are preferably 64 bits long (although one or more special purpose registers may be smaller) and effective addresses are 64 bits long. The instruction unit 570, registers 572 and execution stages 574 and 576 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus, comprising:
a plurality of circuit blocks, each said circuit block including a separate clock grid; and
at least one oscillator circuit operable to select frequencies for at least two respective clock signals and to transmit said at least two clock signals to respective ones of said plurality of circuit blocks.

2. The apparatus of claim 1 wherein said oscillator circuit is operable to select one of said frequencies for each said circuit block.

3. The apparatus of claim 2 wherein said frequency for each said circuit block is selected based on a test result for each said circuit block.

4. The apparatus of claim 2 wherein said frequency for each said circuit block is selected based on a desired power consumption level of each said circuit block.

5. The apparatus of claim 2 wherein said frequency for each said circuit block is selected based on a desired power consumption level of said apparatus.

6. The apparatus of claim 1 further comprising:
a control circuit coupled to said at least one oscillator circuit, wherein said at least one oscillator circuit is operable to select said frequencies in response to control data, received from said control circuit, indicative of said selected frequencies for said plurality of respective circuit blocks.

7. The apparatus of claim 6 wherein said control circuit comprises a storage circuit including at least one of: (i) one or more read-only memories (ROMs); and (ii) one or more electronic fuses for storing said control data.

8. The apparatus of claim 7 wherein said control circuit further comprises a communication circuit operable to transmit said control data from said storage circuit to said at least one oscillator circuit.

9. The apparatus of claim 1 wherein:
said at least one oscillator circuit comprises at least two oscillators, each said oscillator coupled to a respective one of said circuit blocks, the apparatus further comprising:
a control circuit including at least one storage circuit and at least one communication circuit, said control circuit providing control data to said oscillator circuit for said selection of said frequencies for said clock signals.

10. The apparatus of claim 9 wherein said at least one communication circuit comprises at least one data bus operable to transmit said control data from said control circuit to said at least two oscillators.

11. The apparatus of claim 1 wherein:
said at least one oscillator circuit comprises at least two oscillators and at least two multiplexers, each said multiplexer coupled to a respective one of said circuit blocks, the apparatus further comprising:
a control circuit including at least one ROM and at least one communication circuit, wherein said control circuit is operable to transmit control data, indicative of said selected frequencies of said clock signals for said circuit blocks, to said at least one oscillator circuit.

12. The apparatus of claim 11 wherein said at least one communication circuit comprises a plurality of signal lines coupled to respective ones of said multiplexers and operable to transmit said control data thereto.

13. A method, comprising:
providing a plurality of circuit blocks within an apparatus, each said circuit block including a separate clock grid;
selecting respective frequencies for at least two respective clock signals; and
transmitting said at least two clock signals having said respective clock-signal frequencies to at least two of said circuit blocks.

14. The method of claim 13 wherein said selecting comprises selecting one said frequency for each said circuit block.

15. The method of claim 14 wherein said frequency for each said circuit block is selected based on a test result for each said circuit block.

16. The method of claim 15 wherein said test result for each said circuit block is obtained before said apparatus is packaged.

17. The method of claim 14 wherein said frequency for each said circuit block is selected based on a desired power consumption level for each said circuit block.

18. The method of claim 14 wherein said frequency for each said circuit block is selected based on a desired power consumption level for said apparatus.

19. The method of claim 13 wherein said selecting is responsive to control data indicative of said selected frequencies for said plurality of respective circuit blocks.

20. The method of claim 19 wherein said selecting and said transmitting are performed by an oscillator circuit within said apparatus.

21. The method of claim 20 wherein said control data is transmitted to said oscillator circuit from a control circuit within said apparatus.
